(19) United States
(12) Patent Application Publication
(10) Pub. No.: US 2017/0279929 A1
(43) Pub. Date: Sep. 28, 2017

(54) HIGH-PERFORMANCE WEB SERVER, PROTOCOL AND CLIENT

(71) Applicant: THE TRUSTEES OF THE STEVENS INSTITUTE OF TECHNOLOGY, HOBOKEN, NJ (US)

(72) Inventor: Dov Bunim Kruger, Teaneck, NJ (US)

(73) Assignee: THE TRUSTEES OF THE STEVENS INSTITUTE OF TECHNOLOGY, HOBOKEN, NJ (US)

(21) Appl. No.: 15/468,731

(22) Filed: Mar. 24, 2017

Related U.S. Application Data
(60) Provisional application No. 62/313,352, filed on Mar. 25, 2016.

(51) Int. Cl. H04L 29/06; H04L 29/08

(52) U.S. Cl. CPC H04L 67/42; H04L 67/02

(57) ABSTRACT

A protocol, server and client producing high performance web service with security and lower power requirements. A web protocol retrofits web browsers with a translating program on the client to relay the messages to the server with less bandwidth. Optionally, the protocol is embedded within a custom browser to communicate directly, eliminating translation and layers of programming. By storing web pages in a binary format and skipping the intermediate representation of HTML, CSS, and JavaScript the size of the web page, and the time it takes to display it can be reduced. The elimination of JavaScript also increases security because JavaScript is a known, common source of attacks. Communication of static data is minimized. A key repository and automated client use thereof may eliminate manual entry and transmission of access credentials making phishing attacks impossible.

### CROSS REFERENCE TO RELATED APPLICATIONS

The present application claims the benefit of U.S. Provisional Application No. 62/313,352, filed Mar. 25, 2016, entitled, High Performance Web Server, Protocol and Client, which is incorporated herein by reference in its entirety.

### FIELD OF INVENTION

The present disclosure relates to network communication technology, protocols and security.

### BACKGROUND

A web server is a program that listens to incoming requests on a socket and replies with information sent back to a client computer. The earliest web servers would listen for a command, which would be a request for a file. The server receives the command: GET filename. It then opens the file and sends the contents to the client. Later, interfaces such as CGI (Common Gateway Interface) were invented that would execute a program in response to a query so that the output of a web page can be dynamic. The protocol used to send requests and receive responses from web servers conversion is called HTTP: HyperText Transfer Protocol.

Later innovations included maintaining data and programs in RAM on the server for faster response time. CGI runs programs in response to web requests. By contrast, JSP and Java servlets, a later technology, not only store data in-memory but the programs remain in RAM after first loading. Response time for servlets is thus at least an order of magnitude faster than CGI.

The in-memory servers today are far faster than the old CGI servers, but even so, the data being sent to the client has grown. As network speeds grew, web pages have become more complex and rich which means that the total number of files to be shipped from the server to the client has increased, as has the total number of bytes.

In an attempt to improve performance further, as browsers became standardized, JavaScript (a programming language) began to be used to implement client-side logic. A web page can therefore do some computation locally, animating graphics, validating forms, and many other tasks. Today, many web pages include a great deal of JavaScript code to be executed locally.

The advantage of using local programming is that, however large it may be, once it has been loaded it can be cached so that a site consisting of many web pages using a common set of libraries need not load the libraries multiple times. The local programming is used to reduce the amount of data transferred. Instead of sending complete details of the web page which are highly redundant, the server sends only the data and the client draws the screen using its local JavaScript program. This approach is called AJAX (Asynchronous JavaScript and XML).

Last, and highest performance, is the one-page design, an extreme form of AJAX where a single web page is loaded with all libraries, and then the page keeps requesting data from the server and redrawing itself. The entire application is a single web page.

Web pages are currently represented in HyperText Markup Language (HTML), a language that describes the components of a page in a manner that defines what data is on the page, and to a certain extent how that data will appear. Cascading StyleSheets (CSS) is a language designed subsequently to HTML, which can allow the definition of how a page should look: color, fonts, and other decorative features are controlled by CSS and largely supersedes the components of HTML that describe the look of a web page. CSS modifies the way HTML looks by defining how certain named entities should look. HTML can refer to these names. For example, CSS can define that the entire web page should be written in the Helvetica font, with a default size of 12 points, but can define specific features like a user login that use different colors and fonts. While web pages are popular and deliver a good user experience, there are a number of problems with web pages. Web browsers are complicated and any bugs can allow an attacker to improperly access user data when the user visits a web site. Web pages are large, typically the formatting is a factor of 10 larger than the actual data, and often far more. This means that web pages require a lot of bandwidth which takes time to transmit, and considerable amounts of electricity for the server farms that deliver the data. Finally, for secure sites using userid and passwords, attackers are constantly trying to fool users into giving away their passwords. This is done via email (phishing attacks), via fake web pages at sites spelled similarly to the real site (for example, g00gle.com instead of google.com).

### SUMMARY

The present disclosure relates to a client-server system having: a server computer; a client computer with a display; a communication connection between the server computer and the client computer through which digital data can be communicated between the server computer and the client computer; a server program residing on the server computer; a client program residing on the client computer; a server data storage accessible to the server computer, the server data storage storing a plurality of data items, the data items including at least one webpage communicable to the client computer by the communication connection and displayable on the display of the client computer, the webpage having a variable portion that includes at least one variable data item and a static portion, the server program storing the static portion and the variable portion in a manner enabling separate retrieval; and a client data storage accessible to the client computer, the client data storage storing a plurality of data items, including the static portion and the variable portion of the webpage communicated by the server computer over the communication connection to the client computer at a first time; and a second variable portion of the webpage sent by the server computer at a second time, subsequent to the first time, the client program combining the static portion and the second variable portion to form a webpage displayed on the display of the client computer.

In another embodiment, the variable portion transmitted is in binary form.

In another embodiment, the variable portion and the static portion are communicated without meta-data.

In another embodiment, the variable portion has a value expressed in digital form and the value changes prior to being sent from the server computer to the client computer at the second time. In another embodiment, a change in the value of the variable portion triggers the server computer to send the variable portion to the client computer.

In another embodiment, the server computer communicates the variable portion to the client computer periodically.

In another embodiment, the data items on the server data storage include a plurality of webpages, each having static and variable portions separately accessible and each of the plurality of static portions and variable portions are capable of being sent to the client computer at least one time upon receiving a request to do so, the client computer capable of displaying any one of the plurality of webpages using static data that was communicated at the at least one time with variable data that is communicated at a subsequent time.

In another embodiment, the server computer sends the variable portion to the client computer when the variable portion changes while the server computer is connected to the server on the communication link and displaying the webpage, the client computer assembling the static portion with the variable portion for display on the client computer.

In another embodiment, the server computer sends the static portion for a webpage to the client computer when the webpage is changed, allowing the client computer to store and use the updated static portion displayed in a webpage.

In another embodiment, the system utilizes a client-makes-right protocol. In another embodiment, the communication connection is the Internet.

In another embodiment, the communication connection at the first time is a connection other than the Internet.

In another embodiment, before communicating the static and variable portions, the client registers with the server to establish a connection sending a connection request the client picks a crypto key and challenge the crypto key is encoded using the servers public key the server replying to the client with information about the server, including the bit endedness of the server and a set of crypto keys.

In another embodiment, each HTML tag is stored as a whole number and the CSS style is correlated to a numeric ID that can be used as a look up in a fixed array of tags and style implementation objects, which are invoked to create the desired webpage.

In another embodiment, data transmitted on the communication connection is bounds checked.

In another embodiment, updates in the webpage are performed by encoding the difference between versions and compressing.

In another embodiment, the server computer communicates binary data without converting to ASCII.

In another embodiment, a standalone client is created on the client computer which the browser on the client computer treats as a website.

In another embodiment, links encountered by the browser are translated to a CSP protocol to retrieve data which is then translated to HTML.

In another embodiment, a CSP protocol is provided by the browser to compile HTML into a binary description from which a webpage may be drawn.

In another embodiment, the program on the server computer has a table wherein HTML commands are correlated to numbers that may be communicated to the client computer, the server computer translating an HTML defined webpage into a number stream having a protocol interpretable by the client computer, the client computer having a compiler program that draws a webpage based upon the number stream sent by the server.

In another embodiment, the client computer transmits variable data for webpage display to the server computer without a static portion.

In another embodiment, data transmitted on the communications link includes an end of data flag to enable data transmission between the server computer and the client computer to be initiated prior to assembly of the entire data stream.

In another embodiment, the second variable portion at the second time has the same value as the variable portion at the first time.

In another embodiment, the second variable portion at the second time has a different value as the variable portion at the first time.

In another embodiment, a method for communicating webpage data having static and variable portions, between a server computer and a client computer over a communications link, includes the steps of: storing a plurality of data items on a first data storage device accessible to the server computer, the data items including at least one webpage with a portion thereof that includes at least one variable data item and a static data portion that is not variable; communicating the static data portion of data items from the server computer to the client computer by the communications link at a first time; storing the static data portion on a data storage device accessible to the client computer; communicating the variable portion from the server computer to the client computer separately from the static portion at a second time, the client computer assembling the variable portion conveyed at the second time with the static portion communicated at the first time to form a resultant webpage; and displaying the resultant webpage on the client computer.

In another embodiment, the steps of communicating the variable portion, assembling and displaying are communicated a plurality of times to achieve a transaction between the client and the server.

In another embodiment, the transaction is conducted with a volume of data communicated over the communication link that is 1000 times less than the data communicated to conduct the same transaction in which the data is communicated in the form of complete HTML webpages.

In another embodiment, the step of encoding an HTML definition of the static portion in binary, such that a browser on the client computer may decode the binary version of the static portion via a table lookup in a table correlating binary numbers to subroutines corresponding to HTML instructions that may be executed on the client computer to draw a webpage.

In another embodiment, the table includes at least one correlation between a single number and a sequence of HTML instructions.

In another embodiment, further including the step of saving access code data on the client computer, allowing the client to access the server computer and exchange data on the communications link without a user of the client manually entering access data on client computer and sending it to the server to prove identity and authorization of the user.

In another embodiment, the access data is in the form of keys saved in a repository on the client computer and the repository is separately access protected.

### BRIEF DESCRIPTION OF THE DRAWINGS

For a more complete understanding of the present invention, reference is made to the following detailed description of an embodiment considered in conjunction with the accompanying drawings, in which:

FIG. 1 is a diagram showing a web server system operating in normal mode in accordance with an embodiment of the present invention;

FIG. 2 is a diagram showing the web server system shown in FIG. 1 operating in lockdown mode;

FIG. 3 is a diagram showing how the web server system shown in FIG. 1 establishes a client connection;

FIG. 4 is a diagram of a communication between a connected client and server in the web server system shown in FIG. 1;

FIG. 5 is a diagram illustrating three examples of web server responses operating in accordance with the web server system shown in FIG. 1;

FIG. 6 is a diagram of a first embodiment of a client and a server operating in accordance with the web server system shown in FIG. 1; and

FIG. 7 is a diagram of a second embodiment of a client and a server operating in accordance with the web server system shown in FIG. 1.

FIG. 8 is a diagram showing public key encryption for authentication.

FIG. 9 is a diagram showing an authentication procedure in accordance with an embodiment of the present disclosure.

FIG. 10 is a diagram showing a registration procedure in accordance with an embodiment of the present disclosure.

FIG. 11 is a diagram showing a client log-in procedure in accordance with an embodiment of the present disclosure.

FIG. 12 is a diagram showing a repository of keys residing of a client computer in accordance with an embodiment of the present disclosure.

### DETAILED DESCRIPTION OF THE EXEMPLARY EMBODIMENT

The following disclosure is presented to provide an illustration of the general principles of the present invention and is not meant to limit, in any way, the inventive concepts contained herein. Moreover, the particular features described in this section can be used in combination with the other described features in each of the multitude of possible permutations and combinations contained herein.

All terms defined herein should be afforded their broadest possible interpretation, including any implied meanings as dictated by a reading of the specification as well as any words that a person having skill in the art and/or a dictionary, treatise, or similar authority would assign thereto.

Further, it should be noted that, as recited herein, the singular forms ‘a,’ “an,” and “the” include the plural referents unless otherwise stated. Additionally, the terms “comprises” and “comprising” when used herein specify that certain features are present in that embodiment, however, this phrase should not be interpreted to preclude the presence or additional of additional steps, operations, features, components, and/or groups thereof.

In accordance with an aspect of the present disclosure a web server, a client, a new protocol to communicate between them, and a compiler to generate server side programs that use the protocol to send optimal amounts of data are described herein. The protocol replaces HTTP and communicates using data coded in binary, not readable text. Unlike HTML, no metadata is communicated to the client each time, allowing the client and server to negotiate an understanding of each message before communication takes place.

In order to maximize efficiency, the present protocol is defined as client-makes-right. When the client first connects to the server, it receives confirmation of a connection along with the byte-order of the server. If the two are the same, then no work need be done. If the server is the opposite byte-order from the client, then the client translates all requests to the server's byte-order and all the server's responses back to the client's order. This allows the server to be as fast as possible. Only data needed to draw the page is transmitted, thereby reducing overall traffic, dramatically increasing speed, and increasing security of the communications by limiting any opportunity for an adversary to break the code connecting the two parties.

The present disclosure generally relates to a new kind of web server, called a CSP server, and a protocol by which the CSP server communicates to a client, called CSP protocol, through which client computers and servers can communicate efficiently. The CSP protocol allows for communication using data coded in binary, not readable text. Only the data needed to draw the page is transmitted, reducing overall traffic and dramatically increasing speed. Because the protocol is far less complicated than HTTP, less time must be taken to parse messages, so the latency from time of request until the response is sent can also be dramatically reduced. Further, reduced communications is inherently more secure because any transmission of data is an opportunity for an adversary to break the code connecting the two parties. By reducing traffic, security is thus increased. Since servers use a significant amount of electricity, the CSP protocol reduces power consumption.

In order to have a secure conversation on the internet, the messages in both directions must be encrypted in such a way that a third party cannot easily deduce the contents of the messages. The protocol used to encrypt web conversations is HTTPS (HyperText Transport Protocol Secure) which uses SSL (Secure Socket Layer) to implement the encryption. Any encryption is vulnerable to attack based on the size of messages sent using the same cryptography key. The fewer bytes transmitted, and the higher the entropy (more random) those bytes are, the higher the security. Because HTML and CSS contain highly repetitive elements, the traffic is both much larger than it needs to be, and the data itself is somewhat predictable and more subject to attack.

The CSP server system serves to increase the security and performance of transactional web traffic. Transactional web traffic may be defined as a repetitive conversation between client and server in which they are updating data shared between the two. For example, a bank customer may log in and check their balance every day, or check the status of deposits. A soldier on the battlefield may wish to report coordinates of the enemy. In both these situations, an individual web page is just part of an ongoing conversation between client and server. The decoration on the page, indeed any static details on the user screen is redundant. The CSP server system is designed to eliminate all redundant communication between client and server, and do so in a way that allows this conversation with any browser supporting the web server's protocol. This has the effect of giving the highest possible performance of the system, while not requiring custom programming such as Android or iOS apps would require.

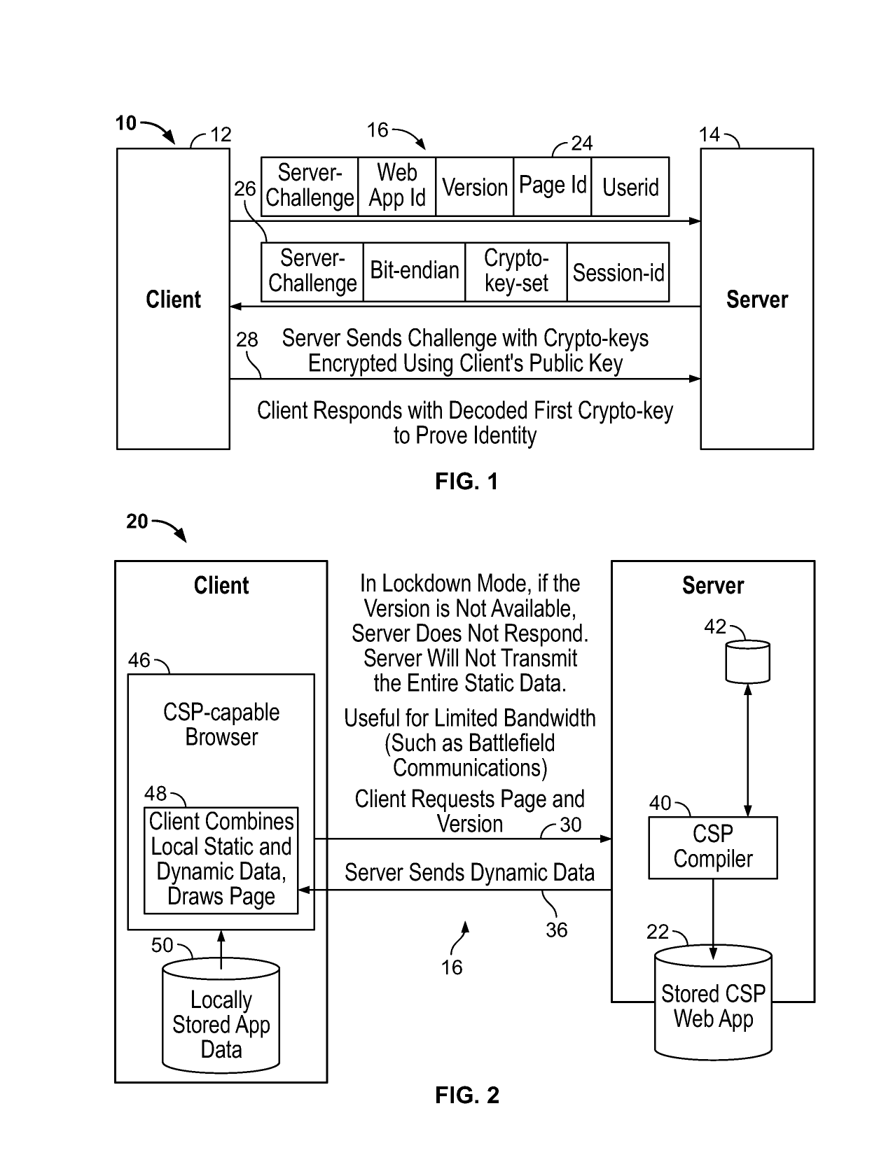

FIG. 1 shows a system 10 in accordance with the present disclosure in the course of a normal conversation under the CSP protocol between a client computer 12 (client) and a server computer 14 (server), which the client 12 initiates over a communication connection 16, e.g., a network, e.g., the Internet, by requesting a particular application and page (webpage). FIG. 2 shows lockdown mode 20, where the client 12 may only communicate with pre-deployed applications 22. Lockdown mode 20 is suitable for high security or limited bandwidth settings, such as the battlefield, where downloading large files would be an unreasonable use of a limited channel.

In FIG. 1, the CSP protocol begins with the client 12 registering with the server 14 to establish a connection, sending a connection request 24. The client picks eight (8) random bytes as a crypto-key and challenge. The crypto key is encoded using the server's public key (this random number is both the challenge for the server, as well as the crypto key for the rest of the client message). The server 14 then replies 26 to the client 12 with information about the server 14, such as the bit-endedness of the server 14 (i.e., big or little), and a set of crypto keys to use for the conversation going forward. The client then sends 28 a decoded cryto-key to prove identity and one or more requests to the server, which the server responds to, e.g., with data for a web page to display on the client 12. The client 12 can end this interaction by either formally requesting an end to communication, or simply letting the conversation lapse.

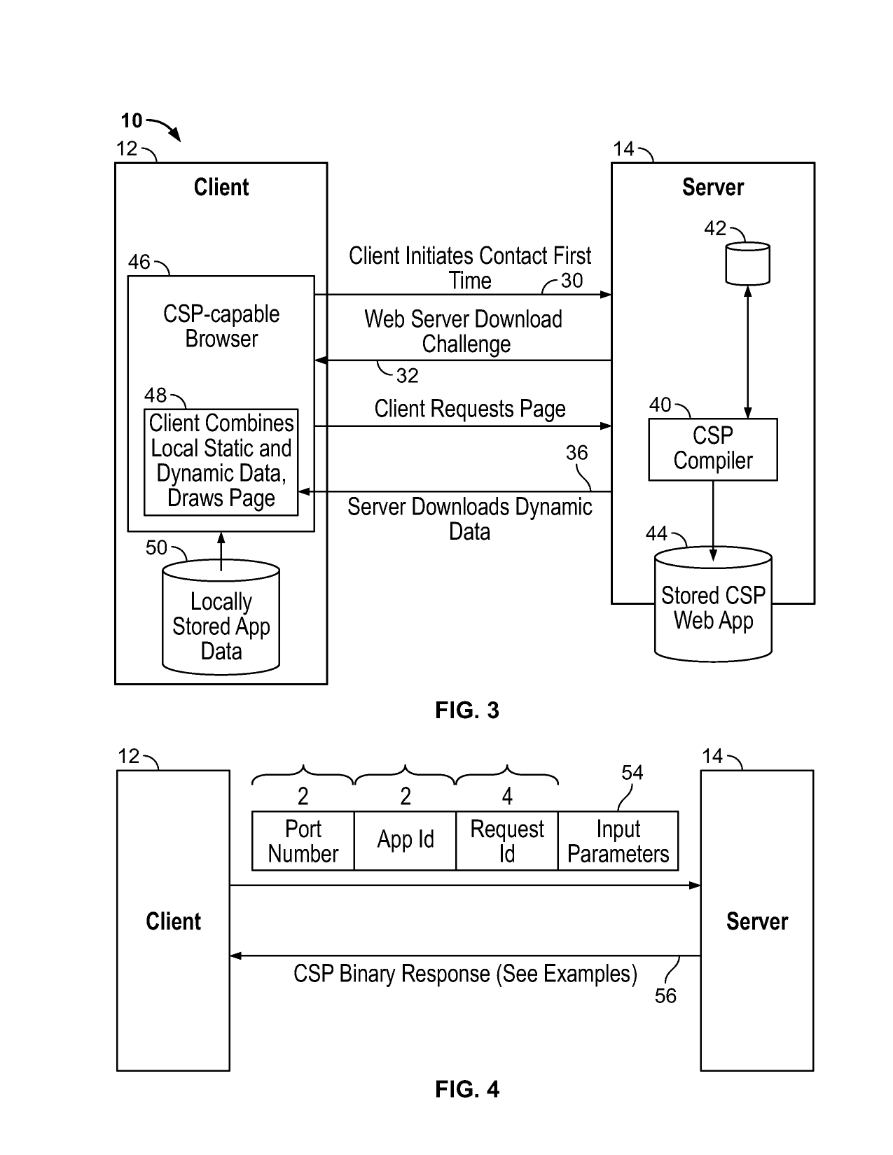

FIG. 3 illustrates how a conversation is started when the client 12 requests a particular application from a server 14 under the CSP server system 10. The client 12 sends 30 a web application id, version number and page id, which indicates which page is desired. The client 12 further identifies the user with a user id which is used to encrypt a message to the user's (already known) cryptography key. Standard public key challenge in SSL is used to determine whether the user is genuine. The server responds 32 with the correctly decrypted server challenge, its byte order (big-endian or little) and one or more cryptography keys to use for a period.

The server 14 has a CSP compiler 40 capable of converting an existing webpage definition 42, for example in HTML, into static and dynamic portions, which can be stored on a CSP web app database 44 such that this information can be separately transmitted to the client 12 by the server 14 via the communication link 16. In response to a client request 34 for webpage data, the server 14 retrieves static and dynamic data from the database 44 and transmits it in a manner that preserves its separation and enables separate handling. The client 12 has a CSP-capable browser 46 capable of receiving, storing and combining 48 the static data and dynamic data to draw the requested webpage on the display of the client 12. The static data may be then stored in a locally stored app database 50. At a subsequent time, dynamic data that is available on the server 14 may be transmitted to the client 12 by itself (without the static data of the webpage). The dynamic data may then be combined 48 with the static data stored in database 50 in order to draw an updated webpage on the display of the client 12. By eliminating transmission of the static data, the time for transmission and power consumed is significantly reduced.

In accordance with the present disclosure, because the server 14 is the more heavily loaded computer, everything is done for its convenience. The client 12 therefore encodes all messages into the correct byte order for the server 14, and will translate from the server's byte order if the two are different (receiver makes right for messages from the server). This protocol is therefore “client makes right.” In the common case where both client 12 and server 14 are Intel-based, no translation is performed between the two, and the only time byte order is mentioned is when communication is initiated.

FIG. 4 illustrates a typical communication between a connected client 12 and server 14 operating in accordance with the CSP protocol. In an initial transmission 50, the client 12 sends a message 54 including the port number, app ID, request ID and input parameters to the server 14. In response the server 14 sends the CSP binary response 56. This binary response 56 may represent all or a portion of the dynamic data of the webpage.

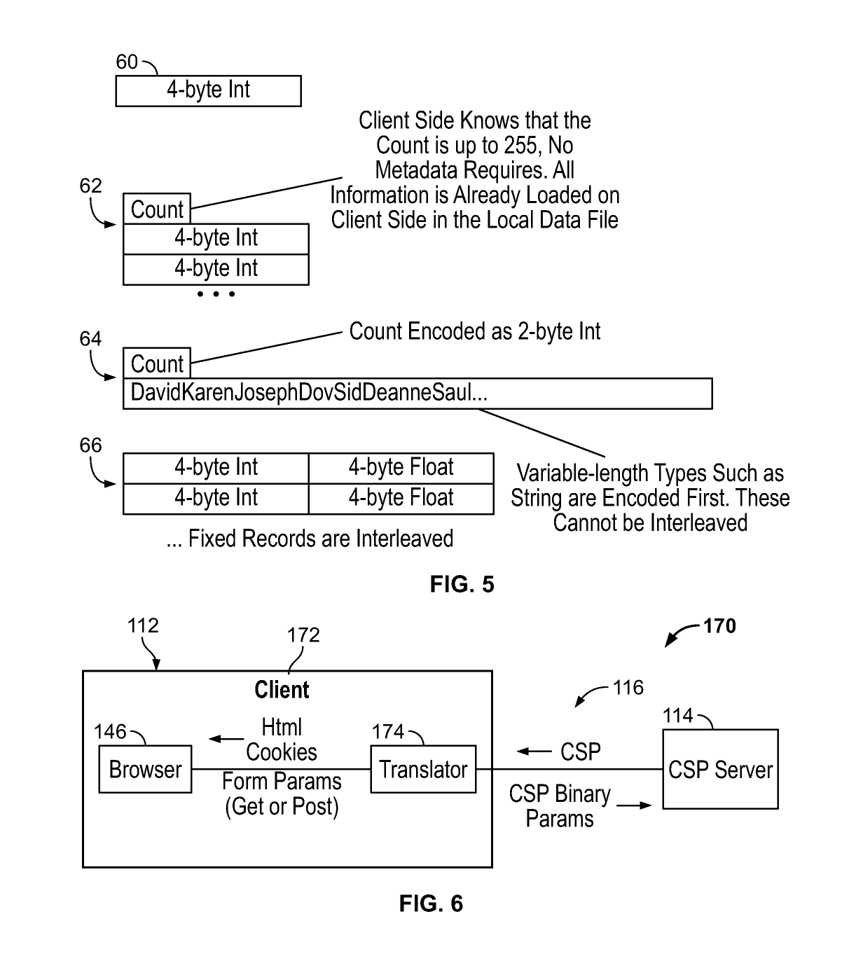

FIG. 5 illustrates examples of CSP responses under the protocol: a simple integer, encoded as four bytes 60; a list of integers 62, encoded as four bytes; and a list of records 64 consisting of names (variable length), age (integer) and weight (floating point). All responses are stored in the server's byte order, which follows the client-makes-right paradigm of the protocol. As shown by 66, fixed records may be interleaved.

An application using the CSP server system 10 is built by compiling a set of secure web pages. All images and static information on the pages is stored into a file stored on database 44. This file is downloaded to the client 12 when the client 12 first contacts the server 14 (normal mode) or must be pre-downloaded and configured (lockdown mode). Whenever a page is requested, the server 14 prints only the dynamic components. The client-side code 48 interleaves the dynamic content with the static and presents it on the browser 46.

Each HTML tag is stored in the CSP protocol as a whole number. Each CSS style is referred to by a numeric id as well. Both numbers are used as lookups into a fixed array of tags and style implementation objects which are invoked to create the desired web page. Using numbers is both more compact and faster, since any name must be used as the key of a hash map to find the underlying object. All entities transmitted in the CSP server system must be bounds checked to prevent an attacker gaining control of one side (client or server) and sending a malformed file containing incorrect static data to the other side designed to go out of bounds.

The data sent for any given message is the dynamic component of the web page. All the static components are prepositioned in the original download. Updates may be performed by encoding the difference between versions and compressing that. In this way, an update need not resend the entire website again, and has high entropy for cryptographic purposes.

The language of the CSP system consists of text which is static, with data interspersed in tags. Using current JSP notation as an example, the system's compiler can parse any tag beginning enclosed within special braces: <% . . . %>. For example:

```
<html>
  <head>
    <link rel=”stylesheet” href=”styles.css”/>
  </head>
  <body>
    <div class=”xyz”>
      <%= x %>
    </div>
  </body>
</html>
```

will print the value of the variable x in binary to the client. The surrounding static text will be sent in the initial file containing the entire static content of the web page. The client 12 recombines the static text in its local storage 50 (FIG. 3) with the bytes sent with the value x and generates this simple web page. If the value of x is 1234, then instead of sending 150 bytes (not counting HTTP header overhead), the server would send 4 bytes (the integer value itself).

The total size of data used in typical banking and brokerage applications is on the order of 100 kbytes for plain html, or 1 Mb for a complex JavaScript application. Some files can be downloaded once, but most browsers will at least check dates in cache each time, so that many messages, sometimes dozens per page will be hit each session for each page. By contrast, the CSP server system 10 does a single version check when the application is first hit. The application can update the client, or not. From that point on, once the client version is known, the only data transferred to the client is binary. Furthermore, server load and latency are dramatically reduced. Not only is the server not transmitting redundant data, it no longer has to read binary data from internal databases, convert to ascii and send. Instead, the data is converted on the client, leaving server-side data manipulation far simpler.

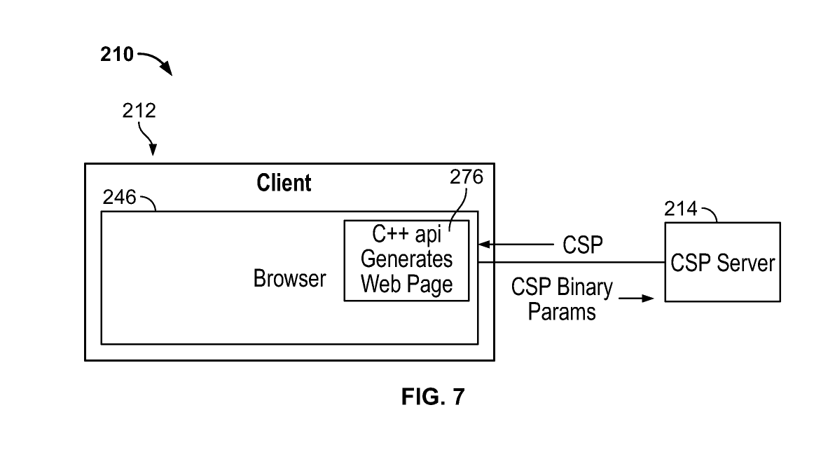

FIG. 6 shows an implementation of the CSP server system 170 by creating a standalone client 172 on the client computer 112 which the browser 146 treats as a website. Every time the browser 146 hits a link, it is translated to the CSP protocol by translator 174, goes across the web (connection 116), and retrieves data, which is then translated to HTML by translator 174. The primary advantages of the CSP server system 170 are increased efficiency by reducing transport over shared links and increasing speed by reducing the load on the server. These certainly apply, however, at the end there is a translation step—the implementation shown in FIG. 6 generates HTML, which is then parsed to create the internal web page. FIG. 7 shows a faster CSP server system 210 in which the CSP protocol is implemented directly by a C++ api 276 that generates web pages within the browser 246. In this case, one can compile HTML into a binary description of the pages which are to be drawn. This approach can bypass multiple layers of inefficiency, including parsing HTML and JavaScript.

The CSP server system uses a compiled language, such as C++, which runs far faster than conventional methods, and since there are a limited set of permitted operations, it does not pose the same kind of security risk as a JavaScript application. A C++ implementation will also use far less memory than JavaScript.

The various embodiments disclosed herein can be implemented as hardware, firmware, software, or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown.

All examples and conditional language recited herein are intended to aid the reader in understanding the principles of the present disclosure and are to be construed as being without limitation to such specifically recited examples and conditions.

### Comparison of HTML, AJAX, and CSP

### Introduction: Protocols and Web Pages

A protocol is an agreed upon language between two computers allowing them to exchange data. There are multiple layers of protocols corresponding to different levels of detail. At the web layer, computers contact each other using sockets and send a stream of bytes back and forth. Web browsers talk to servers using HTTP (HyperText Transport Protocol).

HTTP was designed to be easily visible to humans, so it is encoded in text. If we look at the bytes being sent, the same information could be sent far more compactly. The choice to send messages as plain text was made to facilitate human reading of the traffic without tools, which makes debugging easier, but at a cost in efficiency.

When a user sitting at a browser wants to get a web page, they type a URL like http://google.com. First, the local computer finds the address of google.com and resolves it to an address such as: 216.58.219.238. Then, the computer sends a message using an underlying protocol (TCP/IP) and makes a request for a web page. The server then replies with some information. This disclosure shows some of the details of web page requests, and how to radically improve performance of web transactions, particularly repetitive transactions, such as, checking a bank balance.

### Overview

CSP includes a protocol to exchange web data in which transactions involve repeated conversations between a client and the same server. It dramatically reduces traffic between client and server when the content is highly decorated web pages in which a relatively small amount of dynamic data is displayed. For typical bank balance pages, it can be seen in the next section that the improvement is a factor of 1000 to 2000. For pages with more data, such as listing out all transactions for a month, the improvement is still a factor of 10.

There are many advantages to reducing the size of data sent between client and data, explained in more detail in the following sections. To summarize:
1. The less data sent, the less money and energy is used. Building large server farms to send huge amounts of data is expensive and uses a lot of electricity.
2. The less data sent, the faster the user will experience responses to queries. Users like instantaneous responses, so using the CSP protocol will improve the user experience.
3. Encryption is needed for security on the internet because attackers can be watching traffic between client and server, looking for important data like bank account numbers and passwords. While current web traffic using https (SSL) is secure, there is always the possibility of attacks using all the traffic to figure out the passwords being used to encrypt. The less traffic sent, the higher the security. CSP is far less traffic, and the remaining traffic is far more random, making it far harder to crack the encryption.
4. Websites can be attacked using Denial of Service (DOS) and Distributed Denial of Service (DDOS). The attacker takes over thousands or millions of computers with a virus, and uses the computers to send requests to a server farm to saturate it and make it unavailable to real users. DDOS attacks work far more effectively when a small request keeps a server busy for a long time. Since most web pages today involve a lot of data, it is fairly easy to attack a server by sending it thousands of spurious requests, each of which send hundreds of thousands of bytes of responses. Since CSP reduces the workload for the server, it is far more hardened to DDOS attack.
5. Current web browsers read in code in HTML, CSS, and Javascript to generate beautiful web pages. But interpreting all the instructions is slow and complex. Bypassing these languages for a more compact representation can further improve performance and reduce the size of data transported.
6. JavaScript is a programming language commonly used on web browsers. It represents an important security threat because any bug in JavaScript can allow attackers to steal data from or take over a computer connected to the internet. Currently, JavaScript is heavily used to draw web pages and therefore, no one can use the internet without enabling JavaScript and taking the risk. CSP offers a more secure way of building web pages for important applications such as banking, finance, and military communications.

CSP is designed to replace the current web system for specific applications where security is vital. It offers important performance and security advantages for any website where users must log in and repeatedly access the same data. CSP is not designed to replace web pages for sites that simply display data, though it does offer lesser performance advantages for any website. CSP does not work for any system requiring animation and client-side code (such as a web game with JavaScript code running on the client). But by offering one browser to run CSP for critical tasks such as banking, users can immediately be made more secure against attacks by websites injecting JavaScript malware.

Comparison: CSP Vs. Current State of the Art

### Case 1: Minimal Fetch of a Dynamic HTML Document

Current web communications use HTTP-1.1. In order to compare the benefits of CSP, this section will compare how to send web pages containing dynamic content to a client using simple HTML require a message like the following to be sent to a server:

GET/getbalance.html HTTP/1.1
Host: www.example.com
Connection: close

### Cookie: SESSIONID=X09m13JABAD7XqR

The above request, including control characters is approximately 88 bytes including two bytes to end each line. HTTP-1.1 requests can be far more complicated, with many lines describing how the request should proceed; the above is a representative sample of a very simple request that allows remembering who the client is. The cookie containing the sessionid tells the server which user this is, so each user can have their own account. For security, it is vital that each user not be able to see the cookies of other clients, so this message must be encrypted. Encryption today is done using ssl.

The server sends a response, including an HTTP Header and the HTML file to be delivered to the client. The Header is a minimum of two lines (including one blank line) followed immediately by the file to be sent to the client:

```
Content-type: text/html
<html>
  <head>
    <title>test</title>
  </head>
  <body>
    <img src=″logo.png″></img>
    <div>Account number: 12345678</div>
    <div>Balance: $123.45</div
  </body>
</html>
```

Of all the characters sent back from the server, only the number representing the balance changes each time. Most of the above web page is completely repetitive. Moreover, the picture could be very large. Web browsers are capable of caching the image after the first time, but they will check the timestamp on the file each time to make sure that it has not changed. As a result, a beautiful page with many small images can require hundreds of requests even if it is already loaded, because each file's timestamp is checked to determine whether it has changed, every time. Even though most of the above page is the same every time, it cannot be cached locally on the client because the number embedded inside could change every time. Therefore, the web server must print out the entire page and then send it all, every time. This requires significant work by the server, requiring many servers to handle large loads, using a lot of electricity. This represents millions of dollars a year to a large bank, and is burning fossil fuels to make electricity needlessly.

### Case 2: A Modern JavaScript Approach (AJAX)

Instead of loading the page every time, it is possible to design a page containing a JavaScript program that loads only the data. There are three main disadvantages: First, the JavaScript may be bigger than the original web page (though it loads only once per session). Second, JavaScript is highly insecure because it is an interpreted language, and any bug in the interpreter could allow an attacker to do something dangerous on the client machine. A steady stream of security bulletins show that over the past few years, hackers have been able to use JavaScript and other bugs to acquire passwords from users, steal information from users by using weaknesses in JavaScript to request data from other tabs or windows in the same browser. For this reason, most secure installations do not allow use of JavaScript, and this represents another problem—for any user unwilling or unable to run JavaScript, pages using this approach cannot be accessed at all. Third, writing this code is complicated and labor-intensive compared with the original simple approach, so this kind of programming requires more time and money.

The example below shows an HTML page referring to Java Script, but this time there is no bank balance. Instead every time the page is hit, the javascript loads the data that has changed.

```
<html>
  <head>
    <title>test</title>
    <script src=″ajax.js″></script>
  </head>
  <body onload=″getBalance( )″>
    <img src=″logo.png″></img>
    <div>Account number: 12345678</div>
    <div>Balance: <span id=″balance″></span></div>
  </body>
</html>
```

The following example shows how Java Script may be used to get data from a server-side program.

```
function getBalance( ) {
  var ajax = new XMLHttpRequest( );
  ajax.onreadystatechange = function ( ) {
    if (ajax.readyState === 4 && ajax.status != 200) {
      error(ajax.status);
    } else if (ajax.readyState === 4 && ajax.status === 200) {
        var bal = document.getElementByld(″bal″);
        bal.innerHTML = ajax.responseText;
    }
};
  ajax.open(″GET″, ″/getBalance.jsp″, true);
  ajax.send( );
}
```

The above example makes clear the paradox of high-performance AJAX code. Although it is much higher performance if the user loads the page multiple times, the combination of HTML and JavaScript is much more complicated and more than twice as large. As an example, the first time loading a representative banking login page, The request takes a total of 2.6 seconds using a high speed FIOS home network. There are 104 requests for files with a total of 304 kb of data required. To reload the page, there are still 104 requests, but there is less data (140 kb since presumably some of the files are cached after checking timestamps).

The cost of this transaction can be measured in development cost, energy and cost to operate. To write this witches brew of code (which totals 1 Mb when downloaded) the development cost is many times what an equivalent web page would have been. A simple web page is just layout instructions, and can be done with relatively unskilled labor in a matter of hours—though these designs are complicated, and many people have probably argued over them for quite a while. Still, compared to writing a program to build the web page dynamically, the cost is probably an order of magnitude lower. Then, because the page takes 300 kb to load, every time a user hits the bank website, that data must be delivered across the internet. Multiplied by thousands of simultaneous customers, this means that the bank must purchase a great deal of bandwidth to be able to deliver this traffic in a timely manner, and must maintain a large server farm with enough computing power to send all the data. Running the server farm not only takes money, but a large amount of electricity. Currently approximately 2% of the world's electricity is used to run servers, and while banking is not a huge percentage of that, certainly this cost is at least millions of dollars per year. If traffic could be dramatically reduced, all these costs could be reduced proportionally. There would still have to be a server farm, but if fewer bytes are sent, then fewer computers can handle the same load, using less electricity, which is a gain to everyone, but most of all the bank which saves money as well as reducing environmental damage.

### Case 3: C++ Server Pages (CSP)

By comparison, a CSP request in accordance with the present disclosure for a banking page would download the unchanging file the first time as a single, compressed file. Every time thereafter, one timestamp would ask “Has the website been changed since the last time.” If not, there are no queries to individual files.

In order to get bank balance, the program in CSP could look very similar to the original HTML page:

```
<html>
  <head>
    <title>test</title>
  </head>
  <body>
    <img src=″logo.png″></img>
    <div>Account number: 12345678</div>
    <div>Balance: <%= balance %></div>
  </body>
</html>
```

This code is run through a compiler on the server side, a program that analyzes the page and saves out the static part (everything except the balance). The balance, which appears within the tags <%= . . . . %> is the only data sent from server to client. Suppose the application had 5 pages, each given a unique number:

| | |
|---|---|
| Home page | 0 |
| list accounts | 1 |
| get balance | 2 |
| deposit | 3 |
| make a payment | 4 |

Assuming the server has only a single application on it, the application would be 0. The request would therefore need three pieces of information:

0 2 sessionid

Since there can be many applications and pages within an application, each of these numbers can be stored as 4-byte integers, allowing up to approximately 4,200,000,000 of each. The session id should be 8 bytes for security. The total size of the request is therefore 16 bytes instead of 88+ for HTTP-1.1. The response from the server would be a single 8-byte number, allowing a very large amount of money to be represented, approximately: 180,000,000,000,000.00. This compares to 27 bytes of header+191 bytes for the HTML example and 27+269+27+411 bytes for the example files for the HTML/JavaScript combination or more than three times as large.

The data, when it is received by the client, must be placed in the correct location on the page. One way to think of this is that the client combines the static data (the web page) and the dynamic data (the balance) and creates a web page, which it then feeds to the browser. This is CSP level 1:

```
<html>
  <head>
    <title>test</title>
  </head>
  <body>
    <img src=″logo.png″></img>
    <div>Account number: 12345678</div>
    <div>Balance:_____</div>
  </body>
</html>
```

from server:
1234.56

The number replaces the underscores and the resulting page is displayed locally. In fact, the actual transfer is in binary, so it is not literally the alpha-numeric characters that are filled in the page, but the idea is the same.

The method described above will yield a performance thousands of times higher than either brute force HTML, or AJAX. Each time a client makes a request, the transaction involves (in the above example) 24 bytes compared to hundreds of bytes. In a representative banking example, the transaction involves less than 200 bytes (using the author's banking as an example with multiple accounts), vs. the 304 kb of transfer that currently happens, a factor of 1500. As described in the previous section, this means that far fewer servers can handle the load using less money and electricity, but also means that a user request is serviced far faster, because it takes less time to send small messages. This in turn means that users experience a far faster response time from the server, which is more pleasant in addition to the other benefits.

### Level 2 Optimization

A higher performance method is to build this process into a secure web browser. Instead of interleaving static text on the client with dynamic content from the server and then sending this text to the browser, it is possible to build a browser that allows instructions to more efficiently draw on the screen.

Replacing HTML in a web browser is not nearly as effective as Level 1 CSP. The biggest benefit is to reduce the traffic between client and server, but there are advantages to Level 2, summarized here:
1. CSP does require sending the application to the client one time. This file, consisting of all the web pages from the site compressed, is large. Anything that can be done to reduce this initial load will drop the cost of the initial deployment.
2. It takes time for a web browser to read HTML, decode what it is saying and render the result on the screen. It takes less time than for the data to be sent from the server to the client, but nonetheless, drawing speed of a CSP level 2 includes a specification for an extremely efficient encoding that would allow bypassing the entire input subsystem of the browser. Currently, when a web page is sent to a browser, the program must interpret the tags and create a corresponding page on screen. This takes time. By pre-digesting the tags into a more efficient format, it is possible to significantly enhance rendering speed (probably by a factor of 2-4). This performance improvement is far less than the factor of 1000-2000 for bandwidth reduction, but it is in addition to it. In order to encode a web page in binary, we represent the set of tags as a sequence of numbers. For example:

| | |
|---|---|
| <html> | 0 |
| <head> | 1 |
| <body> | 2 |
| <div> | 3 |
| . . . | |

This can be further optimized by assigning the lowest numbers to the tags that are used the most:

| | |
|---|---|
| <div> | 0 |
| <td> | 1 |
| . . . | |

Each tag would normally refer to a class defining how it looks (font, color, etc). In the same way, CSP defines a table of all the styles currently in use: CSS Style:

0 Helvetica font, 12 pt, background-color: red, etc.

The resulting encoding is:

| | |
|---|---|
| tag class | meaning |
| 0 0 | <div class=″font-family: Helvetica; font-size: 12 pt; |
| | background-color: red″> |

The above two numbers: 0 0 can be encoded at most in two bytes, but can, in fact be compressed and stored in as little as one on average.

By turning the letters of HTML into an internal numeric form, the web browser can read a number, look up in a table, and rapidly pick the correct subroutine to run the code that displays on the screen. By skipping all the layers of code that currently process HTML, and going directly to the code that draws to the screen, a factor of 2-3 speed can probably be gained.

In addition, it is possible to store sequences of commonly defined tags as a subroutine. In programming languages, a subroutine or function is a definition of a sequence of operations to be executed. Writing a subroutine is typically done to eliminate redundant coding of a common operation. Thus for example, if a programmer wants to write a row in a table:
<tr><td>22</td><td>49</td><td>29</td><td>71</td></tr>
   it is sufficient to list out the values and call a subroutine that does the repetitive operation:
drawrow 22,49,29,71
   internally, if drawrow is the first function in the system, this might be encoded as:

| | | | | | | |
|---|---|---|---|---|---|---|
| FUNCTION | 5 | 0 | 22 | 49 | 29 | 71 |

where FUNCTION is a value that indicates that the next bytes are to be treated as a function call, the 5 indicates the length in bytes. The encoding scheme must be capable of representing different-sized numbers, and is discussed below under data types. Again, encoded in binary, the content even of the static components of the web page can now be turned into smaller, faster components that result in faster processing.

In order to maintain security, the web browser can verify that all numbers are within range before executing them. The entire file containing each web application can also be digitally signed to ensure that no one has tampered with the application.

Level 2 CSP requires much more work than level 1, primarily because web browsers are huge pieces of software. But there is no reason this cannot be done. By taking an open-source browser such as Chrome or Firefox and adding a module that renders in binary, the process of sending a request to the server, receiving a reply and drawing on the screen can further be speeded up by a factor of 2-3. For code written for a portable browser like Chrome, this would mean that a single program would allow clients from cell phones and tablets to laptops and desktops, on every major operating system (Windows, Mac OSX, Linux) to run CSP level 2.

### Data Types Supported By CSP

The simple case above shows the relative performance advantage for the extreme case where there is only a single number sent from server to client. In general there can be more data transmitted. CSP supports primitive data types like all major programming languages. This includes numbers (integers of sizes 1, 2, 4, and 8 bytes) floating point scientific numbers (4 and 8 bytes), and strings (sequences of text), and dates. Examples are shown in the following table:

| 12 | | 1-byte integer |
|---|---|---|
| 98765432 | | 4-byte integer |
| 1234567891234567 | | 8-byte integer |
| 6.022 × | 10²³ | 4-byte floating point |
| 1.234567890124 × | 10¹⁰² | 8-byte double precision |

| | |
|---|---|
| A123JX76B | String (a sequence of 8-bit letters to support |
| | English) |
| [symbol] | String (UTF-16 to support big foreign |
| | character sets) |
| A123 [symbol] 567 | String (UTF-8 to support primarily English |
| | with some multibyte characters) |
| 2017.03.05 | A date |
| 2017.03.05 12:00:00.102 | A timestamp (as in what time a bank deposit |
| | occurred) |
| 2145/09/22 12:00:00.1 | A Julian date good for scientific date |
| | calculations |

Other more complicated examples supported by the CSP protocol include:
1. Sending a table of data of different types. Supported data types include any of the primitive types above, and in addition
   a. record (a sequence of different types, ie. first name (String), last name (String), account number (8-byte integer), etc.
   b. List (can be a list of any type, including a record or a list).
      Lists have encoded in them the size, so when transmitting the sender can tell the receiver how many are expected.

An example of a table might be a list of contacts with names, telephone numbers and email addresses (string, integer, string)

| | | |
|---|---|---|
| Dov Kruger | 1239871234 | dovkruger@foonet.org |
| Moshe Kruger | 9911171234 | mkruger@bar.com |

After sending this binary data to the client, the client code would format it into the desired output on the screen, often a table.
2. Dynamic Query. For databases where the size of data can be large and unknown, this data type supports a list of records where only the size of the chunk being sent is known, each time there must be an extra flag saying true/false is there any more data. This is done so a large query may be sent without yet knowing when it ends. This approach increases speed because it is not necessary to wait for a data operation to complete before sending the beginning.

Data in CSP is bidirectional. That is to say, the server (mostly) sends data to the client, but it is possible for the client to submit data to the server. For example, when a user fills in a form, the data is sent from client to the server.

The biggest benefit of CSP is in dramatically reducing bandwidth between server and client while keeping the simple, reliable and secure programming model of original HTTP client/server programming. One portable browser with CSP added can make it possible to use CSP on all client platforms such as Android, Chrome, Windows, Mac OSX and Linux. This is far less expensive than having to write a custom app on each platform, while being just as efficient as a custom app. In addition, since the data is sent in binary form, instead of printing an HTML file and sending it to the browser, it is possible to rewrite the browser to accept binary data.

### CSP Automated Login Security

### Background on Password Security

Secure websites today require two things. First, the entire channel must be encrypted. If this is not done, an attacker somewhere between the client and server can watch the conversation, and learn whatever secrets they need to get into the website. Secure websites therefore use the secure protocol https:// which uses encryption defined in the TLS-1.2 standard[ ].

https://www.ietf.org/rfc/rfc5246.txt

Second, the user must be able to log into the server in a manner that distinguishes them from all other users. This is done using a userid and password. Some websites allow using a standard called open authentication where the website generates a large automatically-generated string which is saved to the client machine and can be used as an alternative kind of password.

In either case, if the user sends their id and password or token to the wrong server, they are giving their secret away. An attacker located on the web server can store the key, and use it to impersonate the user. Many attacks have succeeded by convincing users to enter their userid and password into a website that looks like the normal one, but is a different address. This has happened in many financial scams where criminals loot bank accounts and more recently in stealing DNC emails. A phishing attack is one where an attacker sends an email to a user pretending to be in some way a party related to their website. The attacker invites the user to click on a URL to do something (perhaps to fix a problem with their account). The link takes the user to a website that looks exactly like the real one, but is actually designed to store the userid and password. Often, the attacker then directs the user to the real account, and they do not even know that they have been hacked until their account is used without permission later.

While SSL is a standard used by all web pages, each website typically implements their own password system. There are many problems with this approach. First, each website must implement their own security, so they can be buggy. Programmers designing websites are not necessarily experts in security. Each website has different requirements for the length of the password, what characters must be present, and this causes user frustration and wastes time. A unified security mechanism would allow one strong implementation to be used, rather than each website defining their own rules for passwords and user ids, entering them, verifying them, etc.

### Existing Secure Authentication

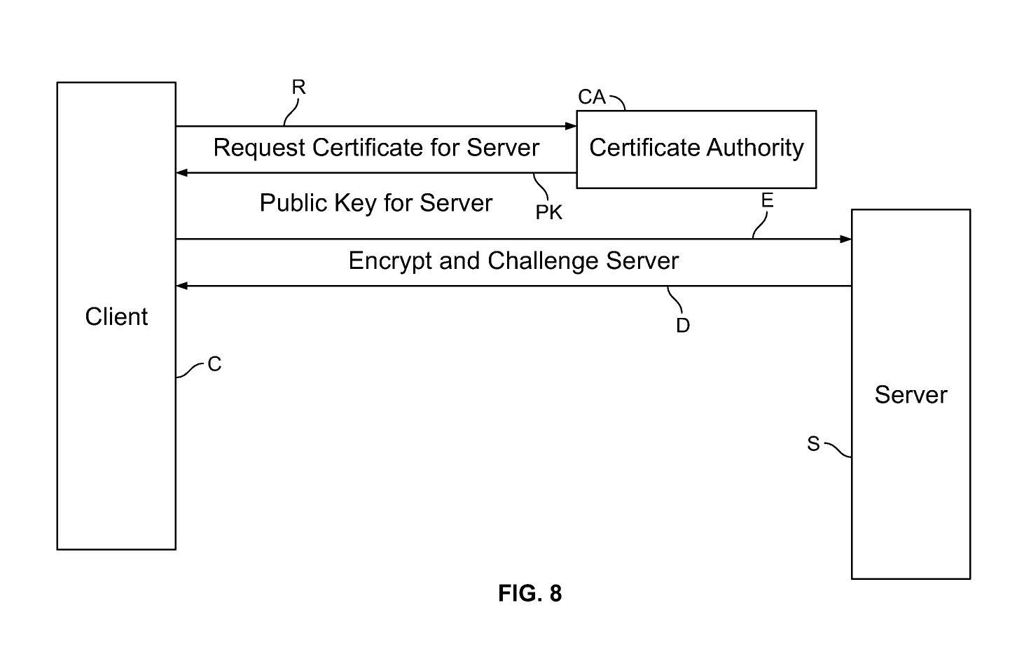

FIG. 8 shows a more secure method of authentication using public key encryption. In public key encryption, there are two keys (public PK and private PVK). The public key PK can be known to everyone, while the private key must be kept secret for security. Only the holder of the private key can decode a message.

Digital authentication is built on top of asymmetric encryption. It is already used to verify that the website being contacted by a user is who it says it is. Digital authentication requires one trusted authority, in this case the certificate authority CA who issues certificates for each website. For example, if we contact google.com, first the web browser contacts the certificate authority CA and asks for the certificate for google. The certificate includes a public key PK, allowing us to encrypt a message that only google can understand. The browser of the client C then picks a random number called the Nonce. In order to verify that the website is really google, the web browser encrypts the nonce and sends it E to the website. If the website is really google, the server can decrypt the number and send it back D, proving their identity.

There are current systems where secure authentication is used in both directions. When logging into a remote computer to type commands, ssh (secure shell) allows the definition of a list of authorized users for password-less login. First ssh verifies that the server is still the same (the first time though, the user must manually verify that the server is ok). Then, the server authenticates the user. No passwords are ever exchanged, and the password used is enormous, on the order of 2000 or 4000 bits long, so it is far more secure than any human-selected password.

### Overview: Secure CSP (S-CSP) Authentication

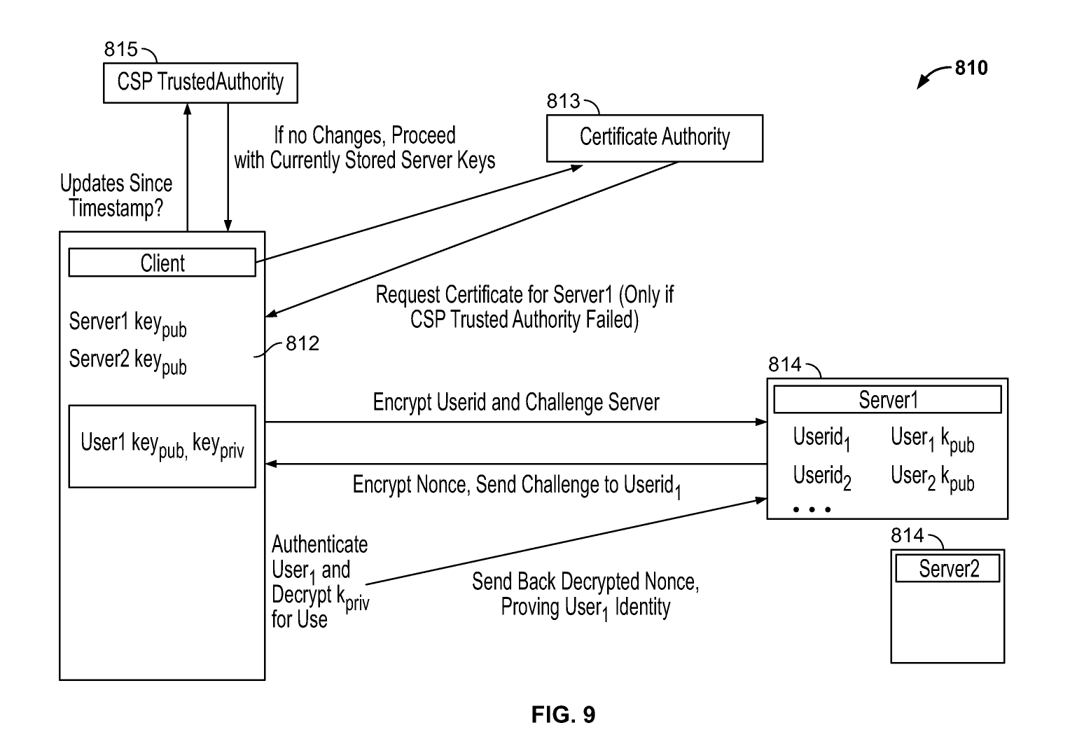

FIG. 9 shows a secure CSP system 810 which is based on digital authentication with some new features. As with https, when the client 812 first connects to the server 814, parameters must be exchanged.

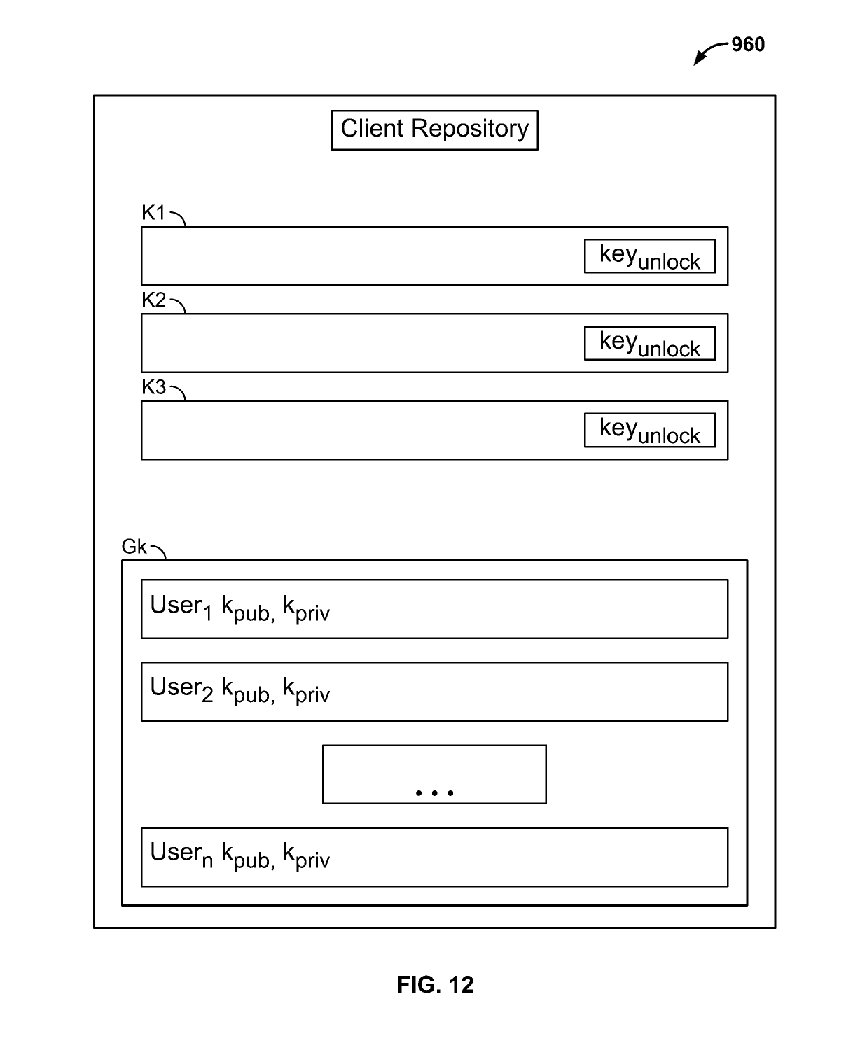

When the client 812 first registers for an account, the server 814 then sends a form of information to be filled out by the user. For example, a bank might want to know customer name, address, phone number, etc. At this stage, the client generates a unique public/private key, stores them securely in the local repository (See FIG. 12). Details of the repository are discussed below in reference to FIG. 12.

First, every time the client 812 connects to the server 814, a number of parameters are automatically exchanged. Features prior to encryption included byte order of the CPU. With the addition of encryption, a supported encryption algorithm must be negotiated as well. The client indicates which revision of the protocol it can handle, and the server replies with the value it decides to go with.

### Connect and Register Sequence

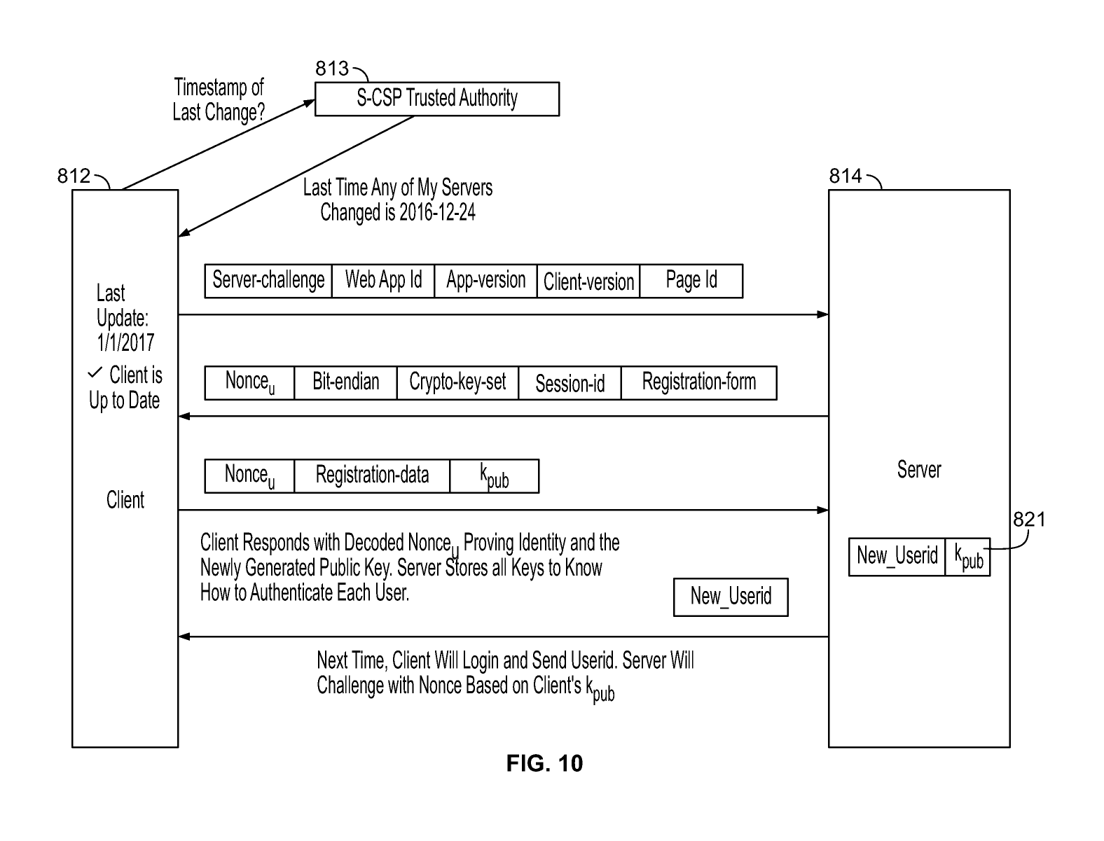

In order to connect and register using S-CSP, the following sequence of messages is sent:
1. The client 812 stores public keys for all servers locally. This means that it does not have to check with a certificate authority (CA) as with a regular browser. However, it is possible that the CA is notified that a server has been compromised. For efficiency, the CSP Trusted Authority 815 can, in a single check, verify the last time that any web site has had a change of certificate or web application. If the client is up to date, it can then directly contact the desired server using the public key it has stored. If the client is out of date, it then contacts a certificate authority 813 (as with a regular browser) and prominently displays the business entity on the screen, and the reason that the record is out of date (for example, certificate was renewed). In other words, before registering private information with a server that has in any way changed, the browser will show the user who the business is, their registered address, etc. For speed, S-CSP defines a faster system with a trusted server for S-CSP. The S-CSP trusted authority server knows, for each S-CSP server, two things: first, when the certificate has last been changed, and second, when the web server has been changed. The client sends a secure, authenticated request to the S-CSP trusted authority asking the last time any server in a common list has been changed. Generally, these servers do not change, so the expected result is a timestamp from a while ago. If the client has been updated more recently, it can safely assume that all its keys and files are up to date.
2. If the date is more recent then the client 812 requests an update for all certificates that have changed from a list of interest to the client. The server 814 replies with a list of the certificates and/or server sites that have changed, and the client 812 can load these and get up to date. Because this rarely happens, this means the average traffic from this certificate authority is extremely short. Moreover, for privacy, the S-CSP certificate authority does not know which website is being accessed, and does not know which site the client is requesting, unless the client is out of date. By keeping this information on the client 812 asking for a timestamp, the utilization of the trusted authority and network traffic to establish contact should be far lower. Because the request is combined with website changes, this means that each website would not have the additional overhead of replying about version numbers—that is already handled when the website is authenticated.
3. If the S-CSP trusted server 814 does not respond (for example, it is under attack and is busy) then the client 812 can default to the current method of asking the trusted authority for a certificate. For comparison, note that in TLS-1.2 (FIG. 8), the client 812 when starting up always asks for the certificate, which is at least hundreds of bytes. FIG. 10 shows a sequence for client registration.
4. The client 812 contacts the server 814, requesting a secure comm link, tells the server 814 what version the client 812 is and the two agree on a level of encryption both can handle. The client 812 sends a nonce encrypted with the server's public key. The server 814 responds by encrypting using this nonce as the session key, simultaneously proving that the server 814 is the one who owns the public key, and establishing a secure private channel.

Individual user keys are stored encrypted by the user. When challenged, the user must type their password or authenticate with 2-factor or biometrically. All information stored on the client is encrypted so it cannot be ready by unauthorized parties, and digitally signed with a Message Authentication Code (MAC) so that an attacker cannot corrupt the file without the user's knowledge.

In FIG. 10, the client 812 requests to register and the server 814 sends the form of registration information. The user fills in the registration information, and the client automatically generates a unique public/private key pair for this website. The server creates a unique user id. There will be more details on this below. The public/private key pair is stored in a file on the client computer 812, encrypted using a user id, password, and other information discussed below. Thus if someone steals the computer, the keys are still safe. The registration form, and the public key randomly generated on the client 812 are sent to the server 814, where they are stored 821. From this point on, every time the server 814 wishes to communicate with user u, they will authenticate by sending a random nonce encrypted to user u, expecting that the client 812 browser will respond with the decrypted number exactly as done for the server 814.

### Connect and Login

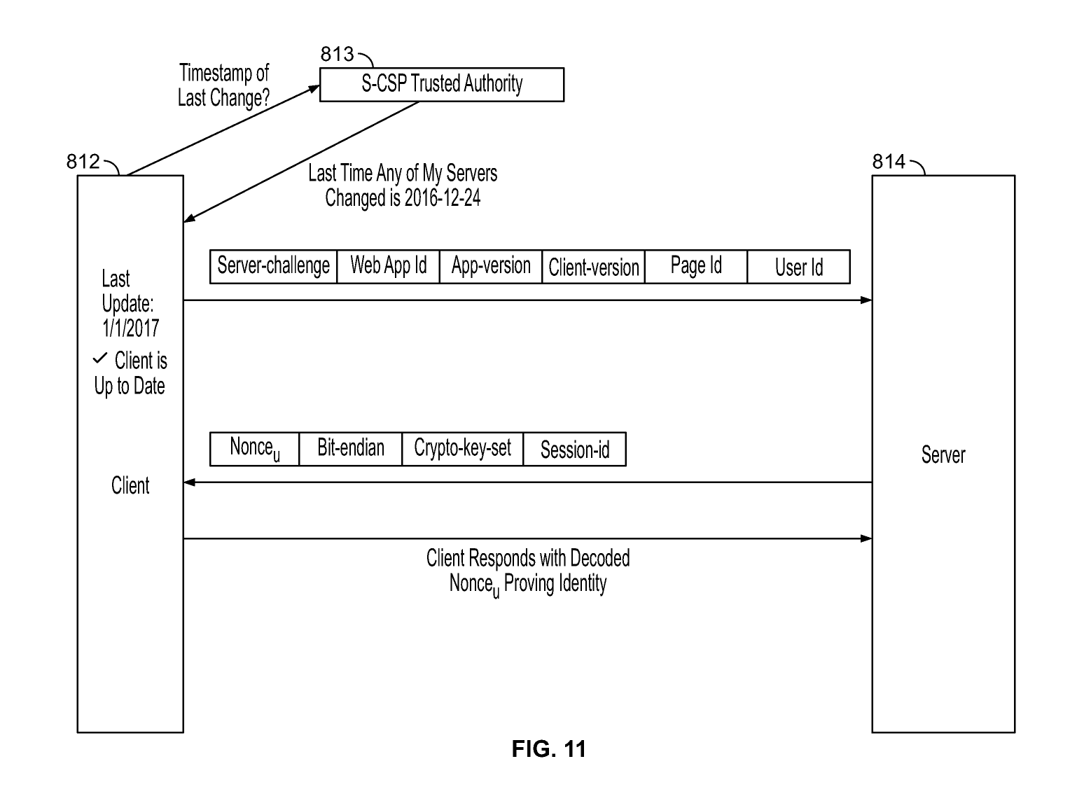

As shown in FIG. 11, connect and login starts the same way:
1. The client 812 requests the S-CSP trusted authority 813, and normally will contact the server 814. Occasionally, it may first have to update either the public key for the server 814 or the file of the application from the server 814.
2. The client 812 challenges the server 814 to establish the server's identity. A nonce is used, and a user id is also transmitted. The server 814 then challenges the client 812 using the public key associated with the user account.
3. The client pops up a dialog asking the user to authenticate. This can happen in one of three ways, which are described below and shown in FIG. 12 as stored in client repository 960.
   a. The user enters userid and password. This is used to decrypt the local private key. The message is decoded, the response is sent, and with both sides satisfied the communication can begin. Note that the userid and password are not sent anywhere. They simply generate a key that is used to decode a single key stored in the local repository. It is this key which is used to decrypt the rest of the repository. An attacker can send a phishing email asking for the user's password, but even if they do so, they can only decode the file by getting access to the repository.
   b. A second factor such as U2F key can be added. This is more secure than just a password. For example, if an attacker watches the user typing, knowing the user's password is insufficient because they must also know the key. In this case as well, no information from the user password or key ever is transmitted. Again, the combination of the user password and second factor unlocks a key at the beginning of the repository that is used to unlock the remainder. In this case, the password will not even unlock the file without the second factor (possession of the physical key); either the password or the key by itself are useless—both are required.
   c. If the hardware U2F key is lost or broken, a mechanism must be provided to retrieving it that does not compromise the security value of the key. After all, if a user can bypass the key, so can an attacker. This can be done in a number of ways: First, two factor authentication using the user's phone (texting a unique key), second by typing one password, setting in motion a chain of events in which a website then initiates a second password. The idea is to use a longer sequence of events, and passwords not normally used so an attacker will have a difficult time guessing them. The final possibility listed here is biometric data. This patent is not proposing these methods: S-CSP defines a mechanism by which whatever password technology is used, multiple passwords can be used to unlock the same repository of keys. This is shown in [Fig. Structure of local repository]
4. Once logged in, the server maintains a single integer with 32 or 64 bits controlling permissions. Bit 0 (the rightmost, lowest bit) is ADMIN privilege, the right to change privileges for this web application. All other bits are defined by the programmers of the application.
5. When entering a page, CSP checks whether the permission bit in the user structure matches the permissions required by the page. If the page requires permissions not allowed to the user, the user is rejected and control is transferred to the login page.

The above makes clear a key feature of CSP, that security and the mechanism to decide which pages are permitted are built right into the engine. It is possible to add a more fine-grained test to determine whether to display a particular piece of information to a user, but the most basic test, whether user u1 is allowed to see page p requires no additional code.

FIG. 12 shows a repository 960 having a plurality of keys K1, K2, K3. In a first example, a user types in user id, password, generates an AES-256 key to unlock. In a second example, the user types in a password and uses a physical key as a second factor for added security. In a third example, the user's biometric data is used to decrypt the third key. The keys K1, K2, K3 may be identical, but each is encrypted to allow three different ways of unlocking the repository: 1. user id, password (less secure), 2. password+2nd factor hardware key and 3. multistep password and/or biometric data for backup in the event (2) fails. Any one of them may be used to unlock the repository while the user is logged in. Optionally, after a few minutes of inactivity the user would have to authenticate again, as signified by key group GK.

### Repositories and Backup of Keys

Each user account may have associated a list of userids that share that account. This allows for cases such as people sharing bank accounts, different keys for the same account located on different computers, and also different levels of access. The following cases show example scenarios:

### Example, Banking

A married couple (Alice and Bob with child Charlie) have some accounts jointly, some separate. Each user's accounts thus contain a number of bank accounts. Each user has a cell phone and a laptop. Access is by user account (not bank account).

Alice has an account with two public keys attached, labelled phone and laptop. Under this account are the following bank accounts:

| | |
|---|---|
| 101 | Joint Checking |
| 102 | Joint Savings |
| 1911 | Personal checking for Alice |
| 2001 | Trust Account for Charlie |

Bob's account contains three public keys, one for phone, laptop and desktop.

| | |
|---|---|
| 101 | Joint Checking |
| 102 | Joint Savings |
| 1911 | Personal checking for Alice |
| 2001 | Trust Account for Charlie |

Charlie, the child, may be given an account with limited access to the funds, may be able to look at the balance, perhaps even withdraw a fixed allowance per week, but does not have full control of the account. The banking application can define permissions OWNER (able to withdraw money, transfer out, see balances, etc), BENEFICIARY (able to see the account), CONTROLLED (able to withdraw limited amounts under supervision). The local branch manager who sets up the account might have ACCOUNTSETUP privilege. Bank employees may be able to look at many customer's accounts, but will not be authorized to withdraw funds from any of them. A very limited set of people have ADMIN privilege, allowing them to change the privilege of users. For security, every time an account is granted privileges, that action should be logged in an audit trail.

### Example, Online Assessment

A testing facility for a college includes permissions REGISTRAR, COURSE_DESIGNER, TEACHER, TA and STUDENT. Students can take tests but cannot edit or grade them. Teachers can create, edit and assign tests in classes they teach (but not in other classes). TAs can change grades and edit assignments, but are not allowed to delete course material.

### Backup of Repositories

A repository used by CSP is a file that is encrypted for security. It contains a MAC (Message Authentication Code) for the purposes of verifying that the file has not been tampered with, and may contain CRC (cyclic redundancy check) or other error correcting codes to be able to repair any byte errors since the file is so critical.

In order to back up this file, it is possible to simply copy or email it to another computer, store it in the cloud, or back it up to a memory stick. The file will not be decodable, however, without one of the ways shown to decrypt it, either a userid/password, a password with hardware key, or biometric data. If these keys are lost, the contents of the file will be forever inaccessible, so security of the keys is vital.

### Reference Implementation

In the current version of CSP, permissions are specified by a tag at the start of a page:

<% permission: ADMIN %>
or:
<% permission: TEACHER, STUDENT %>

This will automatically generate code to deny the user permission to enter this page should the user not have one of the permissions specified. The permissions are specified in a C++ header file called Permissions.hh. A sample file is shown below

```
#ifndef PERMISSIONS_HH_
#define PERMISSIONS_HH_
enum Permissions {
  ADMIN,
  CREATE_ACCOUNT,
  DELETE_ACCOUNT,
  CREDIT_FEES,
  HISTORY,
  OWNER,
  CUSTODIAN,
  ATTORNEY,
  BENEFICIARY
};
#endif
```

The user object is used to store all relevant information needed about the user while logged in. The application may augment the user object, but it must store the permissions. On any page, the following code will determine whether the user has the right to perform an operation must be tested:

if (!user.hasPermission(CREATE_ACCOUNT)) {
// here the programmer does whatever is needed if denied.
}

### Password Repository Storage

A password repository consists of a sequence of public/private key pairs associated with accounts on various servers. The repository is encrypted to protect it from theft in the event that an attacker gains physical access to the computer. A local repository is on the client. As backup and centralization, it is possible to designate a file in the cloud to hold a copy of the keys. This can be done manually, by simply uploading the key file manually, or CSP can be augmented to automatically replicate keys to a file on the cloud. There are four key pieces of information needed:
1. The service (such as dropbox, google drive) to hold the data
2. The URL of the file to store the replicated data
3. The name of the file
4. The offset within the file. This allows storing a file that appears to be, for example, a word document, but actually internally contains binary data with the keys.

The above approach is more resistant to attack than current password services like lastpass. With lastpass, they are believed to have survived an attack because the individual password files are all encrypted, and lastpass does not hold the keys, however lastpass is known to have a vast number of users making them a tempting target. With the CSP approach, there is no single filename, and an attacker would be forced to look through any files held by the user on multiple servers trying to find a file in which there is key data. Even if found, the data is encrypted.

The design of CSP includes provisions to have multiple users share access to entities such as accounts, and supports contingent transfer of secrets. For this purpose we define some key terminology:
An escrow agent is a party who holds keys for someone else.
An advisor is a party (like a lawyer) whose job it is to determine when a condition is met (such as the death of a parent) and take appropriate action (transfer control of accounts to the surviving child).
The beneficiary is the party who will receive the transfer

The transfer of secrets codifies a transaction between two or more parties, often conditionally. For example, a parent wants to arrange that in the event of their death, their accounts pass to a spouse first, and then children. First we will describe a CSP-augmented way to give multiple trusted parties the ability to perform this transaction with less risk due to a rogue employee.

### Scenario 1: A Parent Sets Up a Will Designating Spouse First, Child Second

In this scenario, a parent writes a will which is kept with an attorney. The will typically specifies that the spouse gets the account first, and in the event of the spouse predeceasing, the child gets the contents of the account. In this case we assume one child, and either the spouse or the child gets full access to the account itself, not just the money within. We assume that spouse and child are both aware of the will, and that they have been sent a key, which they hold within their repositories. This key will unlock the information, whenever it arrives. The escrow agent is notified of the firm managing the will. The account owner first encrypts the repository defining access to a subset or the entire repository into a new file and encrypts one copy using the public key of the spouse, and a second copy using the public key of the child. The account owner then submits the files to the escrow agent. The escrow agent can have an automated system so that if the account is not accessed for some time (6 months) the bank automatically attempts to check with the owner via secondary means (email, telephone), but this process can also be manually started by beneficiaries and/or attorney notifying the bank that the account owner is deceased. If contact is not possible, the law firm is automatically contacted. [authorized parties, beneficiaries, attorney have access to list of accounts and places from repository and can automatically notify all parties]. Attacks possible in a traditional setting: a rogue attorney, or an employee at either the law firm or the bank could read the information and try to steal the money. In this case, doing so is much harder because the bank or escrow agent does not have a key that the employee can steal to fake being the user. The attorney does not have the file, but has the right to compel the escrow agent to deliver the file to the party designated in the will. The escrow agent has the file, but cannot decrypt it. Only the heirs can decrypt their copy.

Alternatively, the owner of the account can encrypt the subset of their repository that they desire to give to the heir, and the heir gets the file, but they do not posers the key to decrypt it. The attorney could collude with a beneficiary to request an account early, checked by the bank (the escrow agent) verifying that the owner is still alive) but under no circumstances can bank employees or attorney pretend to be the account owner and access the account itself.

Scenario 2: A Parent Sets Up a Will with Multiple Beneficiaries

In this scenario, since multiple parties are to receive distributions of money, the escrow agent (the bank) has a definition of multiple users with accounts at different banks. Upon being notified of the account owner's death, upon receiving an update from the attorney that the estate is settled, the bank can transfer percentages of the money from the account to each user. Note that this requires permission to deposit to each account, which can either be allowed because banks generally make transfers, or for more security can be explicitly permitted: bank x has the right to transfer in money contingent on death of person P. In either case, a CSP repository has the capability to enable automated transactions of this type, set up in advance, resolving multiple accounts with authorized parties who are trusted yet still have restricted access to assets for safety.

The sequence works as follows:
1. The user creates a database of passwords on their local browser and creates a password encrypting this file. Anyone seizing control of the machine will not have access to the data without guessing the password. It is possible to use two-factor authentication on this file so that both a physical hardware key and a password are necessary to decrypt.
2. The user backs up this file to the internet, using an account such as google drive or dropbox that allows shared files on the internet. The file name can be anything the user chooses so that it is not obvious which file contains passwords. For example, a word document called “War and Peace.doc” can actually contain the database hidden inside. The user can specify multiple, different files on different servers as a backup technique, if desired.
3. Each time the user joins a new website, they fill in a form of whatever customer information is required. The website then issues them a unique userid, a number chosen by the website that is 8 or 16 bytes. The CSP client creates a record with a public and private key specific to that website. The public key is sent to the website.
4. Every time the user logs into the website, the id is automatically sent from the client to server. The server looks up the public key of the client, and issues a standard digital challenge. The user never logs on to the server. Their id and password is never requested, and they are therefore never habituated to give those to websites.

### Key Escrow:

In order to be able to retrieve keys that are lost, while making sure they remain secure is a challenge. Here are some key scenarios:
1. The user loses a physical key and needs to reset. There must be an alternate way of retrieving the data not involving 2-factor encryption in order to recover from losing the key, or forgetting a password.
2. The user wishes to designate heirs who get access to each crypto key in the database in the event of their death.

### Parties:

Owner: designates the other parties and conditions
Beneficiary: receives access to certain keys based on conditions
Key Escrow Agent: holds the keys
Transaction Manager: knows the location of each key

### S-CSP Repository Format

An S-CSP repository consists of three parts:
1. Obfuscation. Text or data preceding the repository to hide the fact that the file is, in fact, a repository. This is called steganography and is primarily to be used in hiding the repository amid cloud data. For example, a repository could be hidden inside a large jpeg image file. Only by inspecting each file might it be possible to determine if it contained a repository.
2. A key section containing the key to decrypt the rest of the repository
3. The repository which is a list of account numbers and keys

In order to be able to use a repository, the program needs to know the name of the file (or URL if it is on the cloud), and the offset within to the real data. A key is generated and all the repository will be encrypted with that key for security. In order to perform any operations on the repository, the user must acquire this key. The index section contains one or more copies of this key, each encrypted so only one user can access. In this way, multiple keys can access the repository.

Method 1: The user enters a userid and a password. These are used to decrypt the key. Encryption will use standard techniques, currently AES-256 with an initial value.

Method 2: The user enters a password and uses a hardware key. This is more secure because an attacker who knows the password still cannot decrypt the data in the repository.

However, a key can be lost or damaged, so in order to recover, a multistep password can be used. Typing in one password will result in an intermediate value, sent to a phone which in conjunction with a second password will then get into the system. Using public key encryption, repositories of password data can be securely backed up in the cloud, shared with heirs conditionally, without allowing third parties such as attorneys and escrow agents with rogue employees access to the underlying accounts.

The present disclosure relates to a system that incorporates a protocol, server and client that combine to produce an extremely high performance web server that is at the same time higher in security and lower in requirements for server power. Level 1 of the web protocol retrofits ordinary web browsers to run more efficiently by having a translating program on the client relay the messages to the server more efficiently. Level 2 of the CSP protocol modifies current browsers to communicate directly in the new way. The advantage of Level 2 is in the elimination of the extra translation step, and multiple layers of programming between the incoming web page in HTML, CSS, and JavaScript and the time it is displayed. The result is a compiled web page that can execute far faster, with far less memory used on the client. Because current high performance web systems use JavaScript, a known vector for attacks, the protocol is also more secure. The present system improves any website in which there is a repeated conversation involving a small amount of dynamic data and a large amount of decoration.

It will be understood that the embodiments described herein are merely exemplary and that a person skilled in the art may make many variations and modifications without departing from the spirit and scope of the present disclosure. All such variations and modifications are intended to be included within the scope of the claims.

I claim:

1. A client-server system, comprising:
(A) a server computer;
(B) a client computer with a display;
(C) a communication connection between the server computer and the client computer through which digital data can be communicated between the server computer and the client computer;
(D) a server program residing on the server computer;
(E) a client program residing on the client computer;
(F) a server data storage accessible to the server computer, the server data storage storing a plurality of data items, the data items including at least one webpage communicable to the client computer by the communication connection and displayable on the display of the client computer, the webpage having a variable portion that includes at least one variable data item and a static portion, the server program storing the static portion and the variable portion in a manner enabling separate retrieval;
(G) a client data storage accessible to the client computer, the client data storage storing a plurality of data items, including the static portion and the variable portion of the webpage communicated by the server computer over the communication connection to the client computer at a first time; and a second variable portion of the webpage sent by the server computer at a second time, subsequent to the first time, the client program combining the static portion and the second variable portion to form a webpage displayed on the display of the client computer.

2. The system of claim 1, wherein the variable portion transmitted is in binary form.

3. The system of claim 1, wherein the variable portion and the static portion are communicated without meta-data.

4. The system of claim 1, wherein the variable portion has a value expressed in digital form and the value changes prior to being sent from the server computer to the client computer at the second time.

5. The system of claim 4, wherein a change in the value of the variable portion triggers the server computer to send the variable portion to the client computer.

6. The system of claim 1, wherein server computer communicates the variable portion to the client computer periodically.

7. The system of claim 1, wherein the data items on the server data storage include a plurality of webpages, each having static and variable portions separately accessible and each of the plurality of static portions and variable portions are capable of being sent to the client computer at least one time upon receiving a request to do so, the client computer capable of displaying any one of the plurality of webpages using static data that was communicated at the at least one time with variable data that is communicated at a subsequent time.

8. The system of claim 1, wherein the server computer sends the variable portion to the client computer when the variable portion changes while the server computer is connected to the server on the communication link and displaying the webpage, the client computer assembling the static portion with the variable portion for display on the client computer.

9. The system of claim 1, wherein the server computer sends the static portion for a webpage to the client computer when the webpage is changed, allowing the client computer to store and use the updated static portion displayed in a webpage.

10. The system of claim 1, wherein the system utilizes a client-makes-right protocol.

11. The system of claim 1, wherein the communication connection is the Internet.

12. The system of claim 1, wherein the communication connection at the first time is a connection other than the Internet.

13. The system of claim 1, wherein before communicating the static and variable portions, the client registers with the server to establish a connection sending a connection request the client picks a crypto key and challenge the crypto key is encoded using the servers public key the server replying to the client with information about the server, including the bit-endedness of the server and a set of crypto keys.

14. The system of claim 1, wherein each HTML tag is stored as a whole number and the CSS style is correlated to a numeric ID that can be used as a look up in a fixed array of tags and style implementation objects, which are invoked to create the desired webpage.

15. The system of claim 1, wherein data transmitted on the communication connection is bounds checked.

16. The system of claim 1, wherein updates in the webpage are performed by encoding the difference between versions and compressing.

17. The system of claim 1, wherein the server computer communicates binary data without converting to ASCII.

18. The system of claim 1, wherein a standalone client is created on the client computer which the browser on the client computer treats as a website.

19. The system of claim 18, wherein links encountered by the browser are translated to a CSP protocol to retrieve data which is then translated to HTML.

20. The system of claim 1, wherein a CSP protocol is provided by the browser to compile HTML into a binary description from which a webpage may be drawn.

21. The system of claim 1, wherein the program on the server computer has a table wherein HTML commands are correlated to numbers that may be communicated to the client computer, the server computer translating an HTML defined webpage into a number stream having a protocol interpretable by the client computer, the client computer having a compiler program that draws a webpage based upon the number stream sent by the server.

22. The system of claim 1, wherein the client computer transmits variable data for webpage display to the server computer without a static portion.

23. The system of claim 1, wherein data transmitted on the communications link includes an end of data flag to enable data transmission between the server computer and the client computer to be initiated prior to assembly of the entire data stream.

24. The system of claim 1, wherein the second variable portion at the second time has the same value as the variable portion at the first time.

25. The system of claim 1, wherein the second variable portion at the second time has a different value as the variable portion at the first time.

26. A method for communicating webpage data having static and variable portions, between a server computer and a client computer over a communications link, comprising the steps of:
(A) storing a plurality of data items on a first data storage device accessible to the server computer, the data items including at least one webpage with a portion thereof that includes at least one variable data item and a static data portion that is not variable;
(B) communicating the static data portion of data items from the server computer to the client computer by the communications link at a first time;
(C) storing the static data portion on a data storage device accessible to the client computer;
(D) communicating the variable portion from the server computer to the client computer separately from the static portion at a second time,
(E) the client computer assembling the variable portion conveyed at the second time with the static portion communicated at the first time to form a resultant webpage; and
(F) displaying the resultant webpage on the client computer.

27. The method of claim 26, wherein the steps D-F are communicated a plurality of times to achieve a transaction between the client and the server.

28. The method of claim 27, wherein the transaction is conducted with a volume of data communicated over the communication link that is 1000 times less than the data communicated to conduct the same transaction in which the data is communicated in the form of complete HTML webpages.

29. The method of claim 26, further comprising the step of encoding an HTML definition of the static portion in binary, such that a browser on the client computer may decode the binary version of the static portion via a table lookup in a table correlating binary numbers to subroutines corresponding to HTML instructions that may be executed on the client computer to draw a webpage.

30. The method of claim 29, wherein the table includes at least one correlation between a single number and a sequence of HTML instructions.

31. The method of claim 26, further comprising the step of saving access code data on the client computer, allowing the client to access the server computer and exchange data on the communications link without a user of the client manually entering access data on client computer and sending it to the server to prove identity and authorization of the user.

32. The method of claim 31, wherein the access data is in the form of keys saved in a repository on the client computer and the repository is separately access protected.
